(19) United States
(12) Patent Application Publication
(10) Pub. No.: US 2026/0072134 A1
(43) Pub. Date: Mar. 12, 2026

(54) FMCW LIDAR SYSTEM AND METHOD FOR SIMULTANEOUS RANGE AND VELOCITY MEASUREMENT

(71) Applicant: Scantinel Photonics GmbH, Ulm (DE)

(72) Inventors: Frank HÖLLER, Aalen (DE); Peter WESTPHAL, Jena (DE)

(21) Appl. No.: 19/387,594

(22) Filed: Nov. 12, 2025

Related U.S. Application Data
(63) Continuation of application No. 17/359,319, filed on Jun. 25, 2021, now abandoned.

(51) Int. Cl. G01S 7/48; G01S 17/34; G01S 17/58; G01S 17/931

(52) U.S. Cl. CPC G01S 7/4808; G01S 17/34; G01S 17/58; G01S 17/931

(57) ABSTRACT

The invention relates to a system and a method for simultaneous range and velocity measurement in an FMCW LiDAR system. A first light source produces first light having a first frequency that varies according to a first chirp rate. A second light source produces second light having a second frequency that is constant or that varies according to a second chirp rate. A splitter separates the measuring light into reference light and output light, and a scanning unit directs the output light towards an object and receives input light that is obtained by reflection of the output light at the object. A detector detects a superposition of the reference light and the input light. A computing unit computes unambiguously the range and relative velocity by analyzing beat frequencies resulting from the superposition. Ambiguities due to Doppler frequency shifts are removed by performing a decision tree analysis.

### CROSS-REFERENCE TO RELATED APPLICATIONS

This application is a continuation application of U.S. patent application Ser. No. 17/359,319, filed on Jun. 25, 2021, entitled “FMCW LiDAR System And Method For Simultaneous Range And Velocity Measurement,” the contents of which are incorporated by reference herein in its entirety.

### BACKGROUND OF THE INVENTION

### 1. Field of the Invention

The invention relates to a system and a method for simultaneous range and velocity measurement relative to a moving or unmoving object on the basis of the FMCW-LiDAR technology. Such systems can be used, for example, in autonomously driving vehicles and can be implemented as photonic integrated circuits (PIC) that do not contain any moving parts.

### 2. Description of the Prior Art

Frequency-modulated continuous wave (FMCW) is a range and radial velocity measuring technology which was originally developed for RADAR applications. If light instead of radio waves are used, this technology is usually referred to as FMCW-LiDAR, in which LiDAR is an acronym for “Light Detection And Ranging”.

In FMCW-LiDAR systems, frequency-modulated light beams scan the environment. A small fraction of the light that is diffusely reflected at an object is received and superimposed with a local oscillator wave. The frequency difference between the two signals, which is usually referred to as beat frequency, is measured and used to compute the range R of the object and the relative velocity v in beam direction. By using a tunable laser as light source and a photodiode as detector, the beat frequency can be extracted directly from the photodiode current, because the photodiode delivers a current that is proportional to the squared sum of the two optical waves (“self-mixing effect”).

If the object does not move relative to the measuring device (v=0), a single measurement with a constant laser frequency tuning rate (FTR) and a subsequent FFT (Fast Fourier Transform) of the temporal measurement signal is sufficient to compute the range R.

If the object moves relative to the measuring device (v≠0), a Doppler shift occurs, which must be taken into account in the distance calculation to avoid systematic errors. Since the velocity v is unknown, at least one further measurement with a different FTR is necessary. Usually there is an up-chirp interval in which FTR is a positive constant rchirp and a down-chirp interval in which the FTR=−r_{chirp}, resulting in a triangular wave like frequency variation. Two measurements, one in the up-chirp and one in the down-chirp interval, double the measurement time for one pixel (here one pixel represents a distance and a velocity information), but with the benefit of obtaining additional velocity information.

In FMCW systems it has to be known whether the Doppler frequency is smaller or larger than the beat frequencies that would be obtained for the stationary case. In RADAR systems this is of little concern, because the Doppler frequency shift is always much smaller than the beat frequencies that would be obtained for the stationary case. However, in LiDAR systems the carrier frequency and also the FTRs are much higher than in RADAR applications. It turns out that for typical FMCW-LiDAR applications the absolute value of the Doppler frequency shift is in the same range as the beat frequencies representing the range information that would be obtained for the stationary case. Since it is unknown whether the Doppler frequency shift is positive or negative, the equations for determining the range R and the velocity v cannot be solved unambiguously. This problem is sometimes referred to as Doppler ambiguity.

One approach to remove this ambiguity is to add a time interval in which FTR=0. This is described by Daniel Nordin and Kalevi Hyyppae in a paper entitled “Advantages of a new modulation scheme in an optical self mixing frequency-modulated continuous-wave system,” Optical Engineering 41(5), 1 May 2002, https://doi.org/10.1117/1.1467063. According to this paper, the additional interval with FRT=0 is introduced between a down-chirp and an up-chirp interval.

The additional interval may also be added between the up-chirp interval and the down-chirp interval, see Chester, David B., “A Parameterized Simulation of Doppler Lidar” (2017), All Graduate Theses and Dissertations, 6794, digitalcommons.usu.edu/etd/6794.

This approach of adding an interval with FTR=0 successfully solves the Doppler ambiguity issue. However, it requires an additional measurement and subsequent FFT computation for each pixel. This impedes attempts to increase the pixel rate.

In this context it should be noted that the requirements of the users—in particular manufacturers of autonomous vehicles—regarding the pixel rate are currently still far beyond what can be provided by LiDAR systems at acceptable costs. This is due to the fact that users generally expect an angular resolution of at least 0.1° with a large field of view (FOV) of at least 40°×20° and a high frame rate of typically 25 fps. These requirements correspond to a total pixel rate of 2 million pixels/s. For this reason it is desirable to remove the Doppler ambiguity with as few sequential FFT measurements per pixel as possible.

WO 2020/064437 A1 discloses an FMCW LiDAR system comprising a light source that includes two lasers. In one embodiment the two lasers simultaneously send optical FMCW signals in different frequency channels. The chirp rate of the two signals has the same absolute value, but opposite signs. The two signals are combined to one beam that scans the object while it is deflected by an AWG that ensures that the beam direction of the two signals is always the same. The beam reflected from the object is de-multiplexed so that one signal in each channel can be detected by a detector that is exclusively associated with this channel. The two measurements, which are usually performed successively during the up-chirp and the down-chirp interval, are thus performed simultaneously, which reduces the measuring time by a factor of 2.

WO 2020/064224 A1 discloses an FMCW LiDAR system that simultaneously produces a plurality of FMCW signals in different frequency channels. All signals have the same frequency variations, in particular the same up- and down-chirp rates. In one embodiment the signals are produced by a plurality of lasers. For scanning purposes the signals are deflected into different directions by a dispersive optical element.

LiDAR systems with light sources comprising more than one laser are also described in US 2017/0090031 A1 and US 2013/0242400 A1.

U.S. Pat. No. 10,578,738 B2 relates to a chirped laser radar system that is described to be capable of unambiguously detecting the range and the velocity relative to a moving target. The system comprises two laser sources having different chirp rates, wherein in one embodiment one of the chirp rates is zero. However, it is not disclosed how the Doppler ambiguity is resolved in this system.

US 2019/0018110 A1 discloses a chip-scale LiDAR system including a first light source to output a first signal and a second light source to output a second signal. The system includes a first and second set of photodetectors to obtain a first and second set of electrical currents from a first and second set of combined signals including a first and second portion of the received signal. A processor obtains Doppler information about the target from the second set of electrical currents and obtains range information about the target from the first set of electrical currents and the second set of electrical currents. However, it is not disclosed how the Doppler ambiguity is resolved in this system.

WO 2020/018805 A1 discloses an FMCW LiDAR system including two light sources having different chirp rates and also addressing the Doppler ambiguity.

### SUMMARY OF THE INVENTION

It is therefore an object of the present invention to provide an FMCW LiDAR system and a method for simultaneous range and velocity measurement in which the Doppler ambiguity issue can be resolved without compromising the available pixel rate.

This object is solved by an FMCW LiDAR system for simultaneous range and velocity measurement. The system comprises a first light source configured to produce first light having a first frequency that varies according to a first chirp rate, and a second light source configured to produce second light having a second frequency that is constant or that varies according to a second chirp rate that is different from the first chirp rate. An optical combiner combines the first light and the second light, thereby obtaining measuring light having at least two different frequency components during a measurement interval. A splitter separates the measuring light into reference light and output light, and a scanning unit directs the output light towards an object along different directions and receives input light that is obtained by reflection of the output light at the object. A detector detects a superposition of the reference light and the input light. A computing unit computes unambiguously a range to the object and a relative velocity between the system and the object by analyzing beat frequencies resulting from the superposition detected by the detector. Ambiguities due to Doppler frequency shifts are removed by performing a decision tree analysis.

While prior art approaches use one light source and require at least three measurements during a measurements interval, the provision of a second light source, in combination with performing a decision tree analysis to remove ambiguities due to the Doppler frequency shifts, makes it possible reduce the number of measurements, and therefore also the number of FFT computations, to only two or—if a third light source is provided—to even one. This results in a significant reduction in memory and computational overhead.

Furthermore, each change of the chirp rate requires a certain adjustment time, which is typically about 5 μs. This adjustment time cannot be used for measurements and therefore reduces the achievable pixel rate. This disadvantage is at least partially eliminated by the invention, because the chirp rate has to change only once or—if a third light source is provided—not at all during a measurement interval.

One of the main advantages associated with the invention is therefore that fewer FFTs have to be performed during a measurement interval of duration T. Since the resolution in frequency space scales with 1/T, the peaks become narrower, which results in a better distance resolution and repeatability.

In order to achieve a high pixel rate, the duration T of the measurement intervals should be as short as possible. It can be shown that the system according to the invention makes it possible to achieve—compared to three successive measurements—a very high signal-to-noise ratio (SNR) particularly if the duration T of the measurement interval decreases. The reason for this is that with three successive measurements, the time-of-flight of the light must be waited for three times. For distant objects this results in multiple waiting times that do not contribute to the signal.

Because the Doppler ambiguity is removed by performing a decision tree analysis, it is not necessary to analyze the signals associated with the first and second light sources separately. Therefore, the system according to the invention does not require different center wavelengths for the first and second light sources, and the received input light does not have to be demultiplexed before being superimposed with the reference light.

The term “decision tree” is to be understood broadly. It includes classical decision trees, but shall also encompass other logic structures such look-up tables that lead to different results depending on a set of conditions that can be mathematically defined.

In an embodiment, the second frequency is constant. The first frequency varies according to a chirp rate CR1 during a first portion of the measurement interval and according to a chirp rate CR2 during a second portion of the measurement interval. The computing unit is configured to compute beat frequencies separately for each portion of the measurement interval, and to compute the range and the velocity by analyzing the beat frequencies measured during both portions of the measurement interval.

This is particularly efficient, because with exactly two light sources, from which one emits light having a constant frequency (i.e. a zero chirp rate), costs and system complexity are low. Control of a light source emitting light having a constant frequency is simple so that also the electronics required for operating the system can be kept simple.

In this embodiment, the computing unit may be configured, when performing the decision tree analysis, to determine, separately for each of the first and second measurement intervals, how many beat frequencies have been measured, and whether there is a beat frequency that occurs in both measurement intervals. Such a decision tree has a small number of levels and nodes and can therefore be handled with little computational efforts.

The chirp rate CR1 in this embodiment may be a positive chirp rate so that the frequency increases during the first portion of the measurement interval. Then the chirp rate CR2 is a negative chirp rate so that the frequency decreases during the second portion of the measurement interval. Preferably, the increase and decrease of the frequency is linear, but small deviations from linearity can often be accepted without compromising the measuring accuracy.

In another embodiment, the system comprises a third light source configured to produce third light having a third frequency that varies according to a third chirp rate that is different from the first chirp rate and the second chirp rate. The computing unit is configured to compute beat frequencies for the first light, the second light and the third light, and to compute the range and the velocity by analyzing said beat frequencies.

As has been explained further above, using exactly three light sources has the advantage that only one FFT has to be performed during each measurement interval, which effectively doubles the pixel rate. Furthermore, no dead time occurs, because the chirp rate does not need to change during a measurement. Apart from that, the SNR gain becomes particularly high if the measurement time Tis reduced.

In this embodiment, analyzing the beat frequencies may include the steps of:
a) assigning the beat frequencies in different combinations to the first light, the second light and the third light,
b) computing, for at least one combination, a preliminary value for the range and preliminary values for the velocity at least for the first light and the second light,
c) determining a combination for which at least two preliminary values for the velocity are sufficiently similar,
d) determining final values for the range and for the velocity by adopting the values computed for the combination determined in step c).

For step c) the criterion “sufficiently similar” will be mathematically defined. For example, it may be defined that the absolute value of the difference between the two preliminary values is smaller than a fixed value or a value that depends on the wavelengths of the light sources and the duration T of the measurement interval. As a matter of course, other threshold conditions, for example relating to the ratio of the two values, may also be used instead.

Usually it will not be necessary to compute for all possible combinations preliminary values for the range and velocity in step b), because the different scenarios do not occur with equal frequency. This significantly reduces the effort required to perform the computations.

In principle, four or more light sources may be used, resulting in correspondingly more beat frequency peaks in the power spectra obtained by FFT. However, such configurations are not preferred, because they require additional hardware and software efforts without providing additional benefit.

In an embodiment, the system comprises an optical circulator connecting the splitter, the scanning unit and the detector so that the output light is directed towards the scanning unit and the input light is directed towards the detector. However, an optical circulator may be dispensed with if other means to route the signals in this manner are used, or if the signal strength of the input light is high enough so that normal power splitters can be used instead of a circulator.

Subject of the invention is also a method for simultaneous range and velocity measurement in an FMCW LiDAR system, wherein the method comprises the following steps:
a) producing first light having a first frequency that varies according to a first chirp rate;
b) producing second light having a second frequency that is constant or that varies according to a second chirp rate that is different from the first chirp rate;
c) combining the first light and the second light, thereby obtaining measuring light having at least two different frequency components during a measurement interval;
d) separating the measuring light into reference light and output light;
e) directing the output light towards an object along different directions and receiving input light that is obtained by reflection of the output light at the object;
f) detect a superposition of the reference light and the input light;
g) computing unambiguously a range to the object and a relative velocity between the system and the object by analyzing beat frequencies resulting from the superposition detected by the detector, wherein step g) includes the step of removing ambiguities due to Doppler frequency shifts by performing a decision tree analysis.

In embodiment, the second frequency is constant, and the first frequency varies according to a chirp rate CR1 during a first portion of the measurement interval and according to a chirp rate CR2 during a second portion of the measurement interval. The beat frequencies are computed separately for each portion of the measurement interval. The range and the velocity are computed by analyzing the beat frequencies measured during both portions of the measurement interval.

When performing the decision tree analysis, it may be determined, separately for each of the first and second measurement intervals, how many beat frequencies have been measured, and whether there is a beat frequency that occurs in both measurement intervals.

Preferably, the chirp rate CR1 is a positive chirp rate so that the frequency increases during the first portion of the measurement interval, and the chirp rate CR2 is a negative chirp rate so that the frequency decreases during the second portion of the measurement interval.

In another embodiment, the method comprises the steps of producing third light having a third frequency that varies according to a third chirp rate that is different from the first chirp rate and the second chirp rate, computing beat frequencies for the first light, the second light and the third light, and the step of computing the range and the velocity by analyzing said beat frequencies.

The step of analyzing the beat frequencies may include the steps of:
assigning the beat frequencies in different combinations to the first light, the second light and the third light,
computing, for at least one combination, a preliminary value for the range and preliminary values for the velocity at least for the first light and the second light,
determining a combination for which at least two preliminary values for the velocity are sufficiently similar,
determining final values for the range and for the velocity by adopting the values computed for the combination determined in step c).

### BRIEF DESCRIPTION OF THE DRAWINGS

Various features and advantages of the present invention may be more readily understood with reference to the following detailed description taken in conjunction with the accompanying drawings in which:

FIG. 1 is a schematic side view of a vehicle approaching an object which is detected by a scanner system according to the invention;

FIG. 2 is a top view of the scanner system device shown in FIG. 1;

FIG. 3 schematically shows the layout of a scanning system according to a first embodiment of the invention;

FIG. 4 is a graph showing the time dependency of the frequency of the two light sources used in the embodiment shown in FIG. 3;

FIG. 5a is a graph showing for the prior art the frequencies of the input light and the reference light of an FMCW LiDAR range measurement system during the up-chirp and the down-chirp interval for a zero relative velocity between the scanning system and the object;

FIG. 5b is a graph showing the beat frequency for the constellation assumed in FIG. 5a;

FIG. 5c is a graph showing an idealized power spectrum for the constellation assumed in FIGS. 5a and 5b;

FIGS. 6a to 6c graphs corresponding to the graphs shown in FIGS. 5a to 5c, respectively, but for a non-zero relative velocity;

FIG. 7 is a graph similar to FIG. 6a, but assuming that the absolute value of the Doppler frequency is larger than the frequency shift due to the range R;

FIG. 8a is a graph showing the frequencies of the input light and the reference light of the range measurement system according to the first embodiment of the invention during the up-chirp and the down-chirp intervals;

FIG. 8b is a graph showing the beat frequencies and the Doppler frequency detected by the detector for the frequencies shown in FIG. 8a of the first embodiment during the up-chirp and the down-chirp interval;

FIGS. 8c and 8d are graphs showing power idealized power spectra after performing a FFT for the frequencies shown in FIG. 8b;

FIGS. 9a to 9c are graphs corresponding to FIGS. 8b, 8c and 8c, respectively, for a scenario in which the same beat frequency occurs during the up- and the down-chirp interval;

FIG. 10 is a graph corresponding to FIG. 8b for a scenario in which slightly different beat frequencies occur during the up- and the down-chirp interval;

FIGS. 11a to 11c are graphs corresponding to FIGS. 9a to 9c, respectively, for a scenario in which one beat frequency occurs both in the up- and down-chirp intervals and an additional higher beat frequency occurs only in the down-chirp interval;

FIGS. 12a to 12c are graphs corresponding to FIGS. 11a to 11c, respectively, for a similar scenario in which the beat frequencies have a different relationship;

FIG. 12d is a graph corresponding to FIG. 8a for the scenario shown in FIGS. 12a to 12c;

FIGS. 13a to 13c are graphs corresponding to FIGS. 9a to 9c, respectively, for a scenario in which two beat frequencies occur both in the up- and down-chirp intervals;

FIG. 14 is a graph similar to FIG. 4, but for a second embodiment in which both light sources generate light having varying frequencies;

FIGS. 15a and 15b are graphs corresponding to FIGS. 13a and 13b, respectively, but for the second embodiment and assuming a scenario in which the largest beat frequency is in the down-chirp interval;

FIG. 16 schematically shows the layout of a scanning system comprising three light sources according to a third embodiment of the invention;

FIG. 17 shows the effect of Doppler shifts on an ideal power spectrum measured with a scanning system shown in FIG. 16; and

FIG. 18 is a diagram showing how the signal-to-noise ratio (SNR) improves with the use of two or three light sources compared to the conventional prior art methods.

### DETAILED DESCRIPTION OF PREFERRED EMBODIMENTS

### 1. Introduction

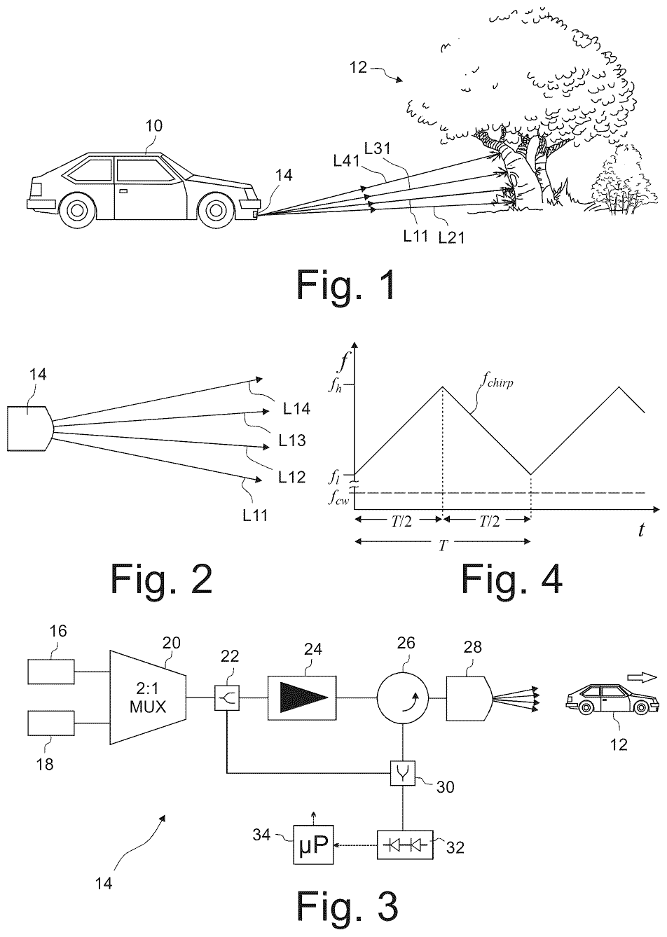

FIG. 1 is a schematic side view showing a vehicle 10 that approaches an object 12 represented by a tree. The vehicle 10 has a scanner system 14 that scans the environment lying ahead of the vehicle 10 with light beams L11, L21, L31, and L41. From range information associated to each light beam, a three-dimensional image of the environment is computationally reconstructed. In addition, the scanner system 14 determines the relative velocity to the object 12. This information is particularly important if the object 12 is not fixed, but moves, too.

The information computed by the scanner system 14 about the environment lying ahead of the vehicle 10 may be used, for example, to assist the driver of the vehicle 10 in various ways. For example, warning messages may be generated if a collision of the vehicle 10 with the object 12 threatens. If the vehicle 10 drives autonomously, range and velocity information about the environment lying ahead are required by the algorithms that control the vehicle 10.

As is apparent in FIG. 1, the scanner system 14 emits the light beams L11 to L41 in different directions in a vertical plane (i.e. the plane of the paper in FIG. 1) so that the environment is scanned in the vertical direction. Scanning also takes place simultaneously in the horizontal direction, as FIG. 2 illustrates in a top view of the scanner system 14.

Four light beams L11, L12, L13 and L14 are emitted simultaneously or consecutively in a horizontal plane in different directions.

For the sake of simplicity it is assumed in FIGS. 1 and 2 that only four light beams Ln1 to Ln4 are emitted vertically and horizontally. However, in real applications the scanner system 14 emits many more light beams. For example, k·2ⁿ light beams are preferred, wherein n is a natural number which is typically between 7 and 13 and specifies how many beams are emitted in one of k (horizontal or inclined) planes, wherein k is a natural number which is typically between 1 and 256.

### 2. First Embodiment

FIG. 3 schematically shows the layout of the scanner system 14 according to a first embodiment of the invention. The scanner system 14 is configured as an FMCW LiDAR system and comprises a first light source 16 and a second light source 18. During operation of the scanner system 14, the first light source 16 produces first light having a first frequency f_{chirp} that periodically varies (“chirps”) between a lower frequency fₗ and a higher frequency fₕ. Typically, the first light source 16 comprises a tunable laser light source or a laser light source emitting light with a fixed frequency which is then frequency modulated, as this is well known in the art as such. However, other types of light sources are contemplated as well.

The graph of FIG. 4 shows how the frequency f_{chirp} of the first light source 16 varies over time t in this embodiment. Each measurement interval having a chirp duration T is divided into two halves of equal length T/2. During the first interval, the frequency f_{chirp} increases linearly with a constant and positive up-chirp rate r_{chirp}, i.e. df_{chirp}/dt=r_{chirp}. The first interval will therefore be referred to in the following as up-chirp interval. During the second interval, the frequency f_{chirp} decreases linearly with a constant negative down-chirp rate −r_{chirp}, i.e. df_{chirp}/dt=−r_{chirp}. This results in a triangular wave like frequency variation as shown in FIG. 4.

In this embodiment, the second light source 18 continuously produces second light having a constant frequency f_{cw} during the up-chirp and the down-chirp intervals. Also the second light source 18 typically comprises a laser light source, but other types of light sources are also contemplated. In FIG. 4, the frequency f_{cw} is indicated with a broken line.

During the round-trip time 2R/c, which the first light requires to get to the object 12 and back to the scanner system 14, the frequency change of the first light should be so small that it can always be clearly distinguished from the frequency f_{cw} of the second light. For a typical distance R=150 m and a chirp rate r_{chirp}=10¹⁴ s⁻², the wavelength of the first light may be 1550 nm, and the wavelength of the second light may be 1554 nm.

Both light sources 16, 18 are connected to an optical combiner 20 that combines the first light and the second light to measuring light having two different frequency components, namely the varying frequency f_{chirp} and the constant frequency f_{cw}. The optical combiner 20 may be realized as an optical 2:1 multiplexer having two input ports and one output port.

The measuring light enters a splitter 22 that separates the measuring light into reference light (sometimes also referred to as “local oscillator”) and output light. In this embodiment, the output light passes an optical amplifier 24 and an optical circulator 26 that guides the amplified output light towards a scanning unit 28.

Instead of using an amplifier 24 that amplifies only the output light, it is also possible, for example, to amplify the measuring light before it enters the splitter 22, to use at least one amplifier arranged in at least one light path between the light sources 16, 18 and the optical combiner 20, or to dispense with the amplifier 24 completely.

The scanning unit 28 directs the output light towards the object 12—in FIG. 3 represented by a moving car—along different directions, as it has been explained above with reference to FIGS. 1 and 2. While some part of each output light beam is usually absorbed by the object 12, another part is reflected. As long as the surface of the object 12 is not perfectly specular, diffuse reflection occurs which ensures that some output light is reflected at the object 12 such that it propagates back towards the scanning unit 28. The reflected output light, which is referred to in the following as input light, is received by the scanning unit 28 and guided towards the optical circulator 26.

The optical circulator 26 passes the input light towards a further combiner 30 that combines the reference light, which was separated from the measuring light by the splitter 22, with the input light. A detector 32 arranged behind the further combiner 30 thus detects a superposition of the reference light and the input light. The detector 32 may be configured as a balanced detector, as this is known in the art as such. The electric signals produced by the detector 32 are fed to a computing unit 34 that computes the range R to the object and a relative velocity v between the scanner system 14 and the object 12 by analyzing beat frequencies resulting from the superposition detected by the detector 32.

Since no light has to be routed from the further combiner 30 towards the splitter 22, using the optical circulator 26 is not mandatory. Often it suffices to use simpler polarization sensitive beam splitting elements instead of the optical circulator 26.

### a) FMCW LiDAR Principle

For a basic explanation of the FMCW LiDAR principle, the second light produced by the second light source 18 will be ignored in the following discussion.

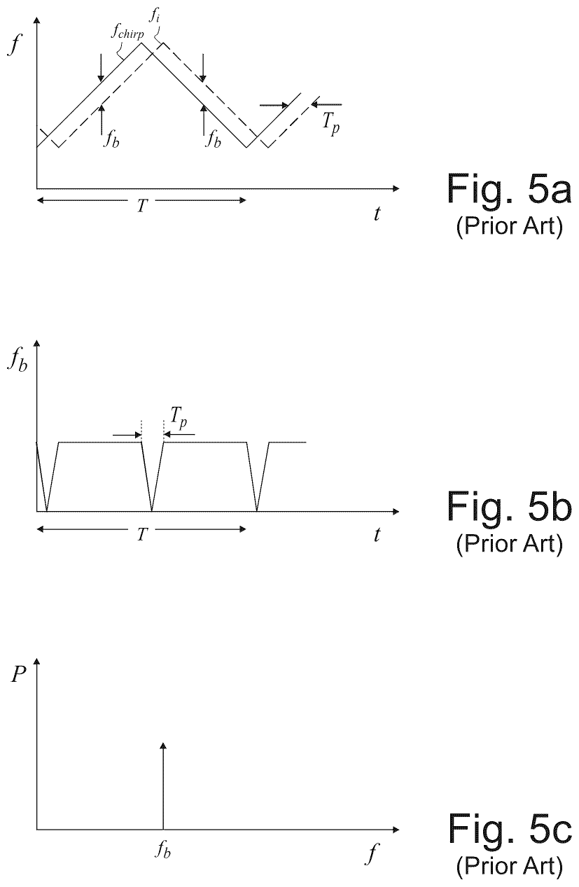

FIG. 5a illustrates the frequencies f_{chirp} of the reference light (solid line) and the frequency fᵢ of the input light (broken line) for the case that there is no relative velocity between the scanner system 14 and the object (v=0). It can be seen that the frequency fᵢ is shifted to the right on the time axis, which is a consequence of the fact that the input light is delayed by the round-trip time Tₚ=2R/c it takes for the output light to reach the object 12 and to return to the scanner system 14 as input light.

Due to the superposition of the reference light and the input light having similar frequencies, the detector 32 detects a beat signal having a beat frequency f_{b} which is equal to the frequency difference at any given time during the measurement interval of length T, as this is shown in FIG. 5a. Since the delay time Tₚ is proportional to the beat frequency f_{b}, the range R to the object can be computed from the beat frequency f_{b} according to

$$R = \frac{T c}{4 Δ f} {f}_{b} \qquad ( 1 )$$

in which Δf=fₕ−fₗ is the total change in chirp frequency during the up-chirp or down-chirp interval of length T/2. Sometimes, this difference Δf is referred to as the bandwidth of the LiDAR system.

FIG. 5b is a graph that illustrates how the beat frequency f_{b} changes during a measurement interval of length T. Since the absolute value of the beat frequency f_{b} is identical during the up-chirp and down-chirp intervals, it suffices to measure the beat frequency once during a measurement interval of length T. FIG. 5b also shows that there is a dead time of length Tₚ each time the sign of the chirp rate changes. During the dead times no useful measurement can be made.

The beat frequency f_{b} can be determined by measuring the intensity I(t) at the detector 32 as a function of time t, followed by a Fast Fourier Transform (FFT) that yields a frequency spectrum P(f) as shown in FIG. 5c for an ideal case, i.e. in the absence of noise and with an infinitely long duration of the measurement interval T. In real systems, it is quite demanding to detect the beat frequency in the noise, because the input light received by the detector 32 has an extremely low intensity.

### b) Doppler Effect

In the following it will be assumed that there is a relative velocity between the scanner system 14 and the object 12 (v≠0). As a result of the relative movement, a Doppler shift occurs that has to be taken into account. The velocity v is defined along the line of light propagation. Sometimes the velocity defined in this manner is referred to as radial velocity.

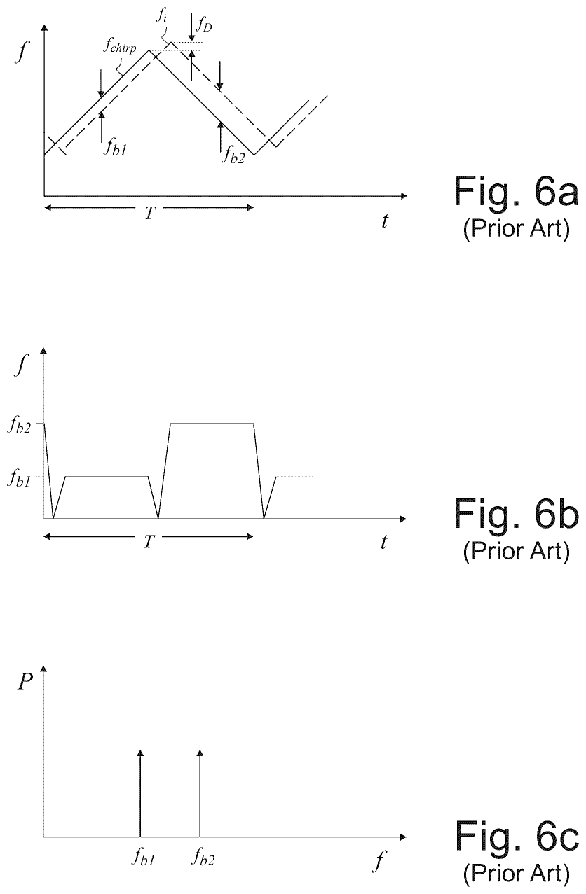

As it is illustrated in FIG. 6a, the frequency fᵢ of the input light (broken line) is not only shifted along the time axis relative to the frequency f_{chirp} of the reference light, but also vertically as a result of the Doppler shift. Here it is assumed that the velocity v is negative, e.g. because the object approaches the scanner system 14. Consequently, the Doppler frequency f_{D} is positive, which implies an increase of the frequency fᵢ of the input light.

As a result of the Doppler shift, the beat frequency is no longer the same during the up-chirp and the down-chirp interval. Instead, in this example, the beat frequency increases during the up-chirp interval and decreases during the down-chirp interval. The resulting beat frequencies f_{b1} and f_{b2} are also shown in the graphs of FIG. 6b and FIG. 6c that correspond to FIGS. 5b and 5c illustrating the stationary case without Doppler shift.

In FIGS. 6a to 6c is assumed that the absolute value of the Doppler frequency |f_{D}| is smaller than the frequency shift f_{R} due to the range R. Then f_{R} and f_{D} can be computed from the detected beat frequencies f_{b1} and f_{b2} according to the following equations:

$${f}_{R} = \frac{{f}_{b 1} + {f}_{b 2}}{2} {f}_{D} = \frac{{f}_{b 2} - {f}_{b 1}}{2} \qquad ( 2 )$$

The range induced frequency shift f_{R} is thus the arithmetic mean of the detected beat frequencies f_{b1} and f_{b2}, while the Doppler frequency f_{D} is one half of the difference between the beat frequencies f_{b1} and f_{b2}.

From the range induced frequency shift f_{R} the range R can be computed according to equation (1), setting f_{b}=f_{R}. The velocity v can be derived from the Doppler frequency f_{D} according to

$$v = {f}_{D} \cdot \frac{λ}{2} \qquad ( 3 )$$

with λ being the center wavelength of the output light.

If the absolute value of the Doppler frequency |f_{D}| is larger than the frequency shift f_{R} due to the range R, a situation as exemplarily shown in FIG. 7 occurs. In that case, f_{R} and f_{D} can be computed from the detected beat frequencies f_{b1} and f_{b2} from equations (4):

$${f}_{R} = \vert \frac{{f}_{b 2} - {f}_{b 1}}{2} \vert {f}_{D} = \{ \begin{matrix}\frac{{f}_{b 2} + {f}_{b 1}}{2} & if {f}_{b 2} < {f}_{b 1} \\ - ( \frac{{f}_{b 2} + {f}_{b 1}}{2} ) & if {f}_{b 2} > {f}_{b 1}\end{matrix} \qquad ( 4 )$$

The problem with this kind of evaluation is that the FFT produces only two frequency peaks as shown in FIG. 6c. However, it is unknown whether the absolute frequency of the Doppler frequency |f_{D}| is smaller or larger than the frequency shift f_{R} due to the range R. Therefore, the above distinction between two different cases cannot be reasonably made, and thus it is not clear whether the Doppler frequency f_{D} is positive or negative.

This ambiguity is not relevant in RADAR applications because the wavelength and the modulation frequencies are quite different. In RADAR applications the absolute value of the Doppler frequency |f_{D}| is always significantly smaller than f_{R}. This is different in LiDAR applications. For example, in a LiDAR scanner system using a wavelength of 1550 nm, the Doppler frequency f_{D} is about 65 MHz for a speed of 180 km/h, while the beat frequencies (which are quite similar to f_{R}) are typically between 5 MHz and 100 MHz. In other words, the absolute value of the Doppler frequency |f_{D}| is just within the range of possible beat frequencies, and there is no way to tell whether the absolute value |f_{D}| is larger or smaller than f_{R}. Without this knowledge, it is not possible to use the correct equations for the computation of the range R and the velocity v.

c) Adding Second Light with Constant Wavelength

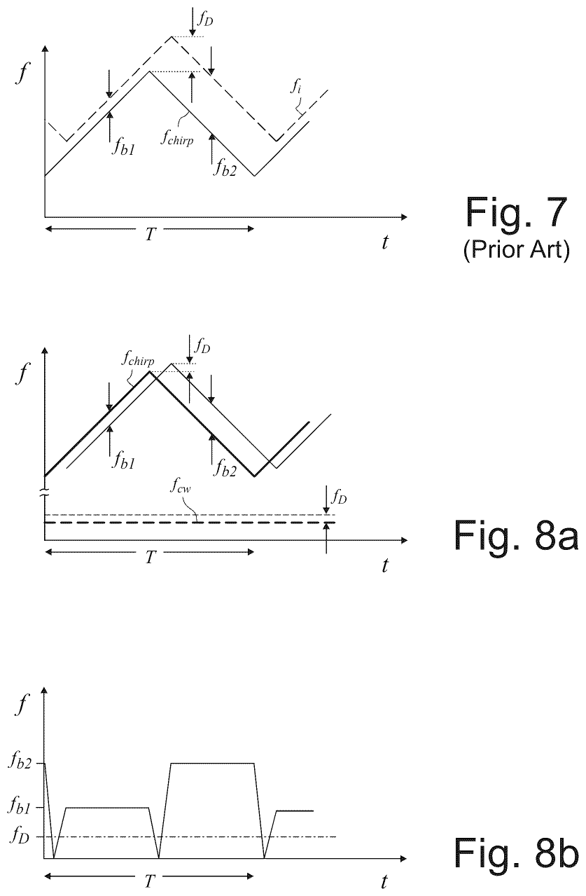

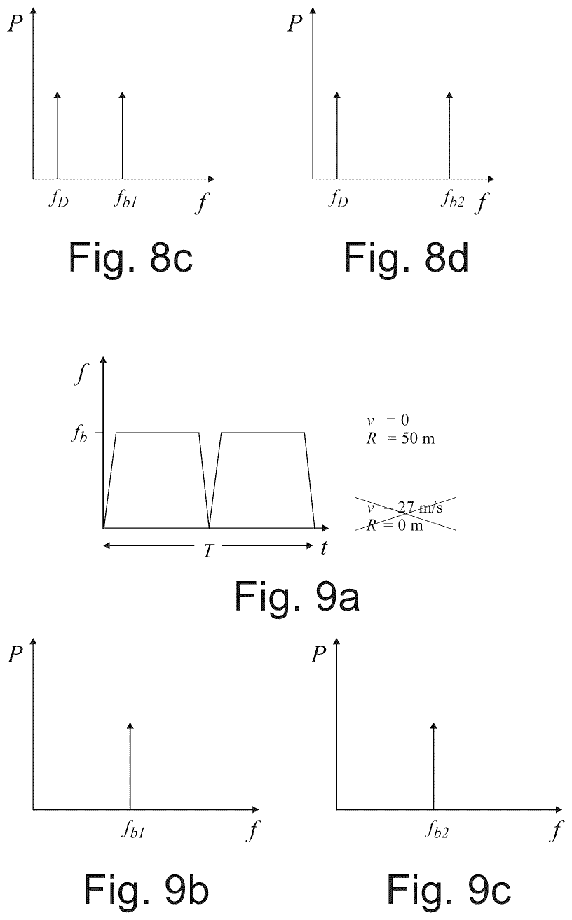

As has been explained above with reference to FIGS. 3 and 4, the scanner system 14 of the first embodiment comprises an additional second light source 18 that produces second light having a constant frequency f_{cw}. FIG. 8a illustrates the frequency f_{chirp} of the first light (bold solid line) and the frequency f_{cw} of the second light (bold broken line). In addition to what is shown in FIG. 4, FIG. 8a also illustrates the two frequency components (thin lines) of the input light, i.e. after reflection at the object 12, for the case of an approaching object (i.e. v<0). It can be seen that both frequency curves f_{chirp} and f_{cw} are shifted “upward”, i.e. towards larger frequencies, as a result of the Doppler frequency f_{D} which is positive in this example.

It can be derived from basic equations of electromagnetic theory that interference of the reference light with the input light results in the following Intensity I(t) at the detector 32:

$$I ( t ) ∼ A + B cos ( ( {r}_{chirp} \cdot \frac{2 R}{c} + 4 π \frac{ν}{λ} ) t ) + C cos ( 4 π \cdot \frac{ν}{( λ - Δ λ )} t ) \qquad ( 5 )$$

with A, B and C being constants and Δλ being the wavelength difference corresponding to the frequency difference Δω=(f_{chirp}−f_{cw}). In this derivation it has been assumed that cosine terms containing Δω are constants, because Δω is very large compared to the other terms (e.g. 3.000 GHz, see further above).

Since Δλ is small compared to λ, equation (5) can be rewritten as

$$I ( t ) ∼ A + B cos ( ( α R + β ν ) t ) + C cos ( β vt ) \qquad ( 6 )$$

$$with$$

$$α = {r}_{chirp} \cdot 2 / c$$

$$and$$

$$β = 4 π / λ$$

From equation (6) it can be concluded that there are generally two frequency peaks in the Fourier spectrum during the up-chirp interval and two frequency peaks during the down-chirp interval. One of the two beat frequencies depends both on the range R and the velocity v and is the result of the interference between the first light and its reflected portion that is affected by the Doppler effect. It is the same beat frequency that would be observed if the second light was absent.

The other beat frequency corresponds to the Doppler frequency f_{D} (see equation (3)) and thus depends only on the velocity v. This frequency is the result of the interference between the second light with and without Doppler shift.

FIG. 8b shows the time dependency of the frequency components of the input light in a representation similar to FIGS. 5b and 6b, and FIGS. 8c and 8d show the frequency peaks obtained in a first measurement during the up-chirp interval and in a second measurement during the down-chirp interval, respectively. These peaks occur in the Fourier spectrum obtained by a FFT of an electrical signal s(t) produced in the detector 32 and corresponding to I(t) according to equations (5) and (6).

By comparing FIGS. 8c and 8d, it can be seen that the left peak (smallest frequency) must represent the Doppler frequency f_{D}, because it is present in both spectra. The other peak in each spectrum must represent the beat frequency f_{b1} during up-chirp and f_{b2} during down-chirp.

There are other scenarios in which it is not that easy to identify the frequencies that are represented by the observed peaks. However, by carefully analyzing the different scenarios that may occur, it is possible to exclude unrealistic scenarios so that correct values for the range R and the velocity v can be computed. This will be explained in the next section.

### d) Analysis of Possible Scenarios

### Two Peaks

There are scenarios in which only two peaks are observed in each Fourier spectrum, a first peak during the up-chirp interval and a second peak during the down-chirp interval. These peaks may be identical or different.

FIGS. 9a to 9c illustrates a first scenario in which the same frequency component f_{b1}=f_{b2} occurs in the spectrum during the up-chirp and the down-chirp interval. One explanation for observing only one frequency peak is that the velocity v and therefore also the Doppler frequency f_{D} equals zero. With this assumption, the range R can be computed according to equation (1) with f_{b}=f_{b1}=f_{b2}. In FIG. 9a it is assumed that the values for T, f_{b} and Δf result in a range R=50 m.

Another explanation for observing only one frequency peak would be that both beat frequencies are zero, i.e. f_{b1}=f_{b2=0}. This would imply a range R=0 and lead to a velocity v≠0, for example 27 m/s. However, such a result is not plausible, because a high relative speed cannot occur if the object 12 is positioned directly in front of the scanner system 14 (R=0). This solution must therefore be discarded.

This implies that if two peaks occur in the spectrum, the velocity v must be zero, and the range R is computed according to equation (1).

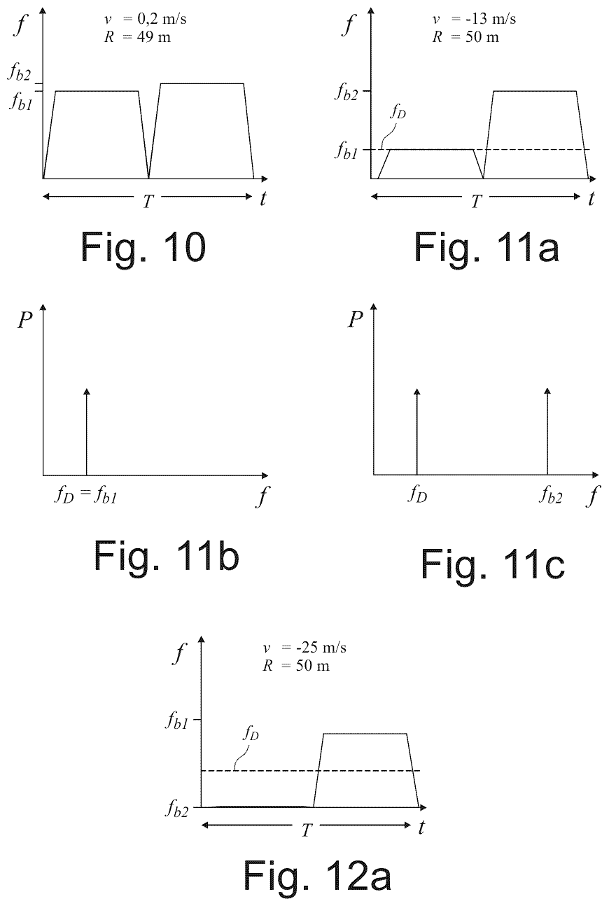

FIG. 10 illustrates a two peak scenario in which the two frequency components f_{b1} and f_{b2} are slightly different. A reasonable explanation for this scenario is that the Doppler frequency f_{D} is so small such that it cannot be detected. Since |f_{D}| is much smaller than the beat frequencies, the range R and the velocity v have to be computed according to equations (1) to (3).

A scenario with two significantly different peaks during up-chirp and down-chirp interval cannot occur. Such peaks could only be a result of a strong Doppler shift, but the Doppler frequency f_{D} cannot be equal to two different beat frequencies.

A scenario in which there are two peaks in the up-chirp and no peak in the down-chirp interval (or vice versa) cannot occur. Such invalid measurements could only be explained by artefacts or noise and must be discarded.

### Three Peaks

If three peaks occur, the situation is more complicated, but there is still an algorithm making it possible to unambiguously determine the range R and the velocity v.

### Type 1

FIGS. 11a to 11c are graphs similar to FIGS. 9a to 9c that illustrate a scenario with one identical peak both in the up-chirp and in the down-chirp interval and an additional peak in the down-chirp interval. The only reasonable explanation for this scenario is that the Doppler frequency f_{D} appears both in the up-chirp and the down-chirp interval, but coincides with the beat frequency f_{b1} in the up-chirp interval.

From the lower frequency peak in the down-chirp interval (see FIG. 11c) the absolute value of the Doppler frequency f_{D} can be derived, but not its sign. However, from equation (6) the condition

$${f}_{b 1} = \vert α R + βν \vert = \vert βν \vert \qquad ( 7 )$$

can be derived for the up-chirp interval, because both frequencies have the same magnitude. From this condition it becomes clear that v must be negative, because all other quantities (including α) are positive. Then equation (7) can be rewritten as

$${f}_{b 1} = α R + β v = - β v \qquad ( 8 )$$

from which the quantities R and v can be computed as

$$R = \frac{2 {f}_{b 1}}{α} and v = - \frac{{f}_{b 1}}{β} \qquad ( 9 )$$

FIG. 11a indicates exemplary values v=−13 m/s and R=50 m.

From equation (6) follows that also for the second beat frequency f_{b2}=|αR+βv|. Using equation (9) yields the relationship f_{b2}=3f_{b1}.

As a matter of course, the same considerations apply, mutatis mutandis, if the there are two peaks in the up-chirp interval and only one peak in the down-chirp interval.

### Type 2

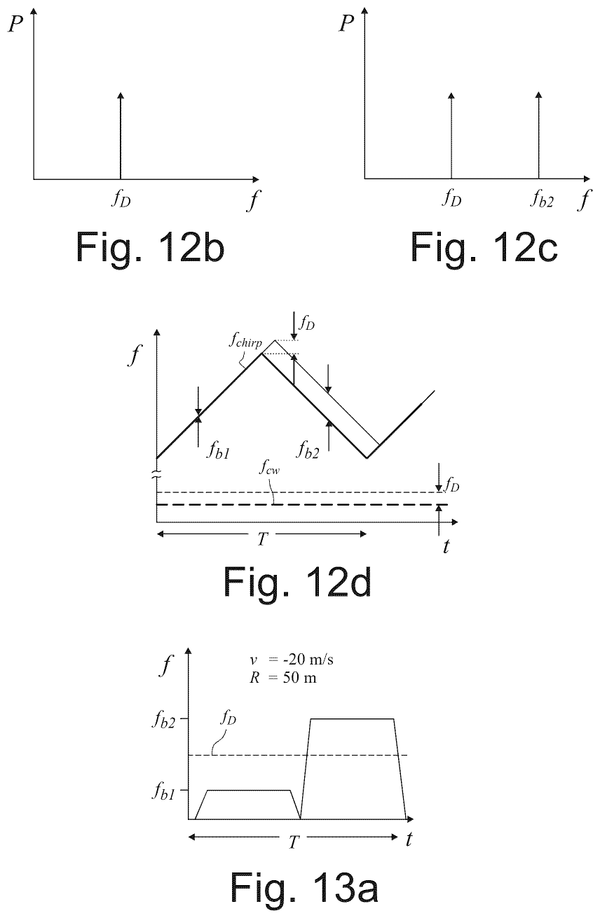

FIGS. 12a to 12c are graphs similar to FIGS. 11a to 11c that illustrate another scenario with one identical peak both in the up-chirp and in the down-chirp interval and an additional peak in the up-chirp interval. The two scenario types differ with regard to their relationship between the beat frequencies f_{b1} and f_{b2}. While in the type 1 scenario f_{b2}=3f_{b1}, the relationship f_{b2}=2f_{b1} holds for the type 2 scenario.

The only reasonable explanation for this scenario is that the frequency shift caused by the range R is completely compensated for by the Doppler shift during the up-chirp interval, as this is illustrated in FIG. 12d. For equation (7) this implies that |αR+βv|=0. As r_{chirp} and thus also a are positive during the up-chirp interval, the velocity v must be negative. The values for R and v are then given by

$$R = \frac{{f}_{b 2}}{α} and v = - \frac{{f}_{D}}{β} \qquad ( 10 )$$

As a matter of course, the same considerations apply, mutatis mutandis, if there are two peaks in the up-chirp interval and only one peak in the down-chirp interval. In that case the velocity v will be positive.

### Four Peaks

In most measurements there will be four peaks in the spectra, two peaks in the up-chirp interval and two peaks in the down-chirp interval. All scenarios in which there are three or all four peaks in either the up-chirp or down-chirp interval are invalid because there is no reasonable explanation for them. Such measurements have to be discarded.

If two peaks during the up-chirp interval and two peaks during the down-chirp interval are observed, there are different scenarios that can be easily distinguished.

If all four peaks are different, the measurement has to be discarded, because there is no reasonable explanation for such a scenario. The Doppler peak must always be equal in both intervals.

The same is true for scenarios in which the peaks in the up-chirp interval are the same as in the down-chirp interval. If there is a Doppler shift, the beat frequencies f_{b1} and f_{b2} must be different.

The two types of valid four peak measurements have already been discussed above in section 2.b), but will be briefly explained again in the following.

### Type 1

FIGS. 8a to 8d discussed above illustrate a scenario in which the velocity v and thus the Doppler frequency f_{D} is small. The Doppler frequency f_{D} can be clearly identified as the identical peak occurring in both measurements. For small Doppler frequencies, the range R and the velocity v can be computed according to equations (1) to (3). The sign of the v velocity depends on whether f_{b1} is larger or less than f_{b2}. In FIGS. 8a to 8d it is assumed that f_{b2}>f_{b1}. According to equation (2), this results in a positive Doppler frequency f_{D} and thus in a positive velocity v according to equation (3).

From equation (2) it can be derived that in this case the Doppler frequency f_{D} must be twice the difference between the beat frequencies f_{b2} and f_{b1}. If this condition is grossly violated, the measurement is invalid and has to be discarded.

### Type 2

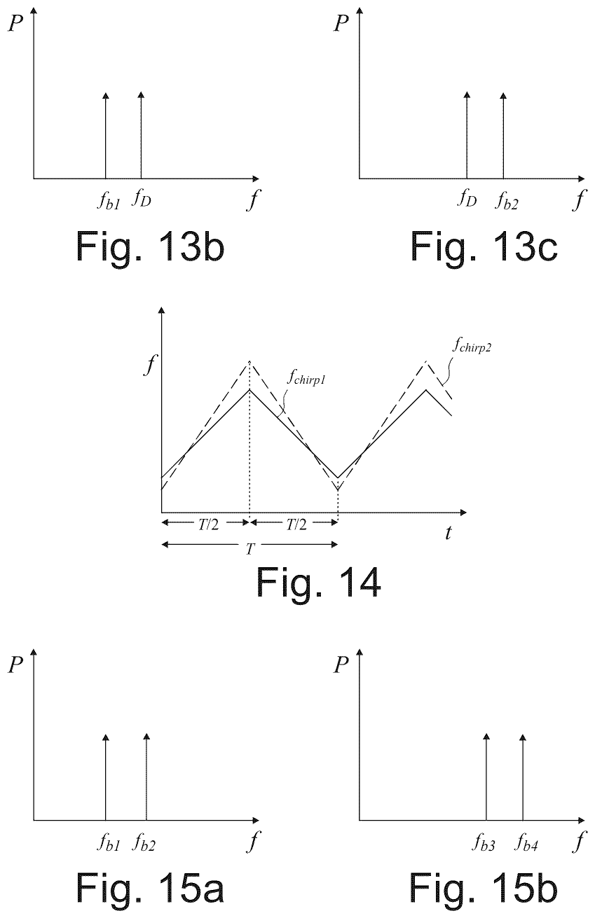

FIGS. 13a to 13c illustrate a scenario in which the velocity v and thus the Doppler frequency f_{D} is large (|f_{D}|>f_{R}). The Doppler frequency f_{D} can again be clearly identified as the identical peak occurring in both measurements. For large Doppler frequencies, the range R and the velocity y can be computed according to equations (1), (3) and (4). The sign of the v velocity depends on whether f_{b1} is larger or less than f_{b2}. In FIGS. 13a to 13c it is assumed that f_{b2}>f_{b1}. According to equation (4), this results in a negative Doppler frequency f_{D} and thus in a negative velocity v according to equation (3).

From equation (4) it can be derived that in this case the Doppler frequency f_{D} must be the arithmetic mean of the beat frequencies f_{b2} and f_{b1}. If this condition is grossly violated, the measurement is invalid and has to be discarded.

If the Doppler frequency is smaller than both beat frequencies f_{b1} and f_{b1}, this can only be the result of an invalid measurement, because then the Doppler frequency f_{D} cannot be equal to the arithmetic mean of the beat frequencies f_{b2} and f_{b1}.

### e) Intermediate Result

It has been demonstrated that by adding second light having a constant wavelength, it is possible to resolve the Doppler ambiguity. In all valid scenarios values for the range R and the velocity v can be is unambiguously computed from the measured spectra during the up-chirp and the down-chirp interval.

### f) Alternative Approaches

As can be seen in FIG. 8b, for example, the Doppler frequency can be observed continuously at any time during the measurement interval of length T, whereas the beat frequencies are interrupted between the up-chirp and down-chirp intervals. This can be used to clearly distinguish the Doppler frequency f_{D} which removes any ambiguities.

However, identifying the Doppler frequency during the short interruptions between up-chirp and down-chirp intervals can be difficult due to noise issues. The identification can be made more reliable by selecting a higher or lower intensity for the second light. Another option is to apply a slow amplitude modulation to the second light so that it becomes easier to identify the frequency peaks directly.

### 3. Second Embodiment

In the first embodiment discussed above the second light source 18 produces second light having a constant frequency f_{cw} during the up-chirp and the down-chirp intervals. As it has been demonstrated above, the range R and the velocity v can then be unambiguously computed.

It is also possible to use a second light source 18′ that produces second light having a frequency f_{chirp2} that also varies over time similar to the first light produced by the first light source 16. In that case the frequency change must be different, i.e. for the chirp rates r_{chirp1}, r_{chirp2} of the two light sources 16 and 18 the condition |r_{chirp1}|≠|r_{chirp1}| must apply, as this is illustrated in FIG. 14. The measurement procedure is then basically the same as described in the context of the first embodiment. Therefore, the intensity I(t) at the detector 32 is measured as a function of time t, followed by a Fast Fourier Transform (FFT) that yields one frequency spectrum P(f) for the up-chirp interval and one spectrum for the down-chirp interval.

Unlike in the first embodiments, in which also two or three peaks can be observed in the two spectra, there will be always two peaks in each spectrum. Nevertheless, there are two main scenarios with a couple of different sub-scenarios that can then be distinguished.

### a) Largest Beat Frequency is in Down-Chirp Interval

If the largest beat frequency occurs in the down-chirp interval, as this is shown in FIGS. 15a and 15b, the velocity v must be negative. The range R and the velocity v can then be computed according to equations (11):

$$R = c \frac{{f}_{b 4} - {f}_{b 3}}{2 \cdot ( {r}_{chirp 2} - {r}_{chirp 1} )} \qquad ( 11 )$$

$$v = - \frac{R \cdot ( {r}_{chirp 1} + {r}_{chirp 2} ) - {f}_{b 4} - {f}_{b 3}}{{f}_{b 1} + {f}_{b 2}}$$

### b) Largest Beat Frequency is in Up-Chirp Interval

If the largest beat frequency occurs in the up-chirp interval, the velocity v must be positive. The range R and the velocity v can then be computed according to equations (12):

$$R = c \frac{{f}_{b 2} - {f}_{b 1}}{2 \cdot ( {r}_{chirp 2} - {r}_{chirp 1} )} \qquad ( 12 )$$

$$v = - \frac{R \cdot ( {r}_{chirp 1} + {r}_{chirp 2} ) - {f}_{b 2} - {f}_{b 1}}{{f}_{b 1} + {f}_{b 2}}$$

For the beat frequencies f_{b3} and f_{b4} the following definition applies:

If there is a beat frequency in the down-chirp interval between f_{b1} and f_{b2}, this frequency is f_{b4}, and the other beat frequency in the down-chirp interval is f_{b3}. If there is no beat frequency in the down-chirp interval between f_{b1} and f_{b2}, f_{b4} is the smaller of the two beat frequencies, and f_{b3}, and the other beat frequency in the down-chirp interval is f_{b3}.

The range R and the velocity v can thus be unambiguously computed.

As a special case, the two chirp rates may have the same absolute value, but opposite signs, i.e. r_{chirp}2=−r_{chirp1}. Equations (12) then simplify correspondingly.

### 4. Third Embodiment

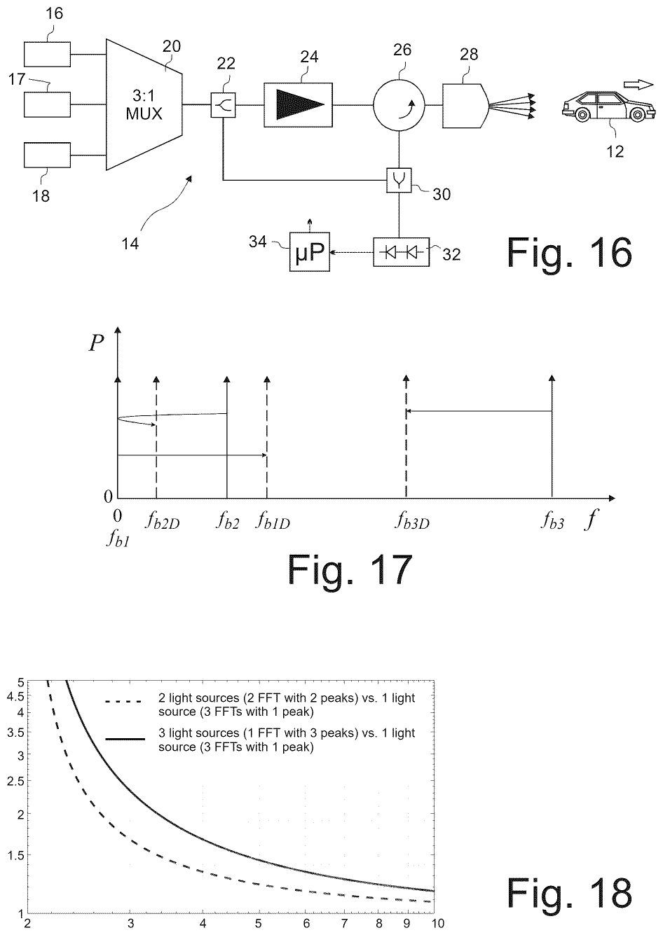

In the first and second embodiments discussed above, the scanner system 14 comprises two light sources producing light having different chirp rates (in the first embodiment, one of the chirp rates is zero). FIG. 16 shows the architecture of a scanner system 14 that comprises not two, but three light sources 16, 17 and 18 having different chirp rates, and preferably emitting light beams having different center wavelengths as well, although this is not mandatory. With equal center wavelengths, it is difficult to identify the desired beat frequencies among the beat frequencies being a result of the superposition of the three reference light portions. One approach to overcome this problem would be to provide three completely distinct light paths, and to ensure that the light spots on the object do not overlap. However, this significantly adds to the system complexity and costs.

As will become apparent from the following description, the configuration with three light sources has the benefit that not two, but only one measurement is required per measurement interval of length T. Nevertheless, the range R and the velocity v can be unambiguously computed as in the other embodiments.

FIG. 17 shows an ideal power spectrum P(f) (i.e. a spectrum in the absence of any noise and assuming an infinite duration T of the measurement interval) comprising three beat peaks at frequencies f_{b1}, f_{b2} and f_{b3} without Doppler effect (solid lines) and at frequencies f_{b1D}, f_{b2D} and f_{b3D} shifted by the Doppler effect (dashed lines). Here it is assumed that the chirp rate r_{chirp} of the first light source 16 is 0 Hz so that the beat frequency f_{b1} is also 0 Hz. For the other two light sources 17, 18 it is assumed that the beat frequencies f_{b2} and f_{b1} are 33 MHz and 133 MHz, respectively.

TABLE 1
Frequency assignment and preliminary range and velocity computation

| | | Preliminary | Preliminary |
|---|---|---|---|
| | | range | velocity |
| | | computation | computation |
| | | according | according |
| Case | Frequency Assignment | to equation | to equations |
| A | f_{b1D} = fₘᵢₙ, f_{b2D} = f_{mid}, f_{b3D} = fₘₐₓ | (13) | (16) |
| B | f_{b1D} = fₘᵢₙ, f_{b2D} = f_{mid}, f_{b3D} = fₘₐₓ | (13) | (17) |
| C | f_{b1D} = fₘᵢₙ, f_{b2D} = f_{mid}, f_{b3D} = fₘₐₓ | (14) | (18) |
| D | f_{b1D} = f_{mid}, f_{b2D} = fₘᵢₙ, f_{b3D} = fₘₐₓ | (14) | (18) |
| E | f_{b1D} = fₘₐₓ, f_{b2D} = fₘᵢₙ, f_{b3D} = f_{mid} | (14) | (18) |
| F | f_{b1D} = fₘₐₓ, f_{b2D} = f_{mid}, f_{b3D} = fₘᵢₙ | (15) | (19) |
| G | f_{b1D} = fₘₐₓ, f_{b2D} = fₘᵢₙ, f_{b3D} = f_{mid} | (15) | (19) |
| H | f_{b1D} = f_{mid}, f_{b2D} = fₘᵢₙ, f_{b3D} = fₘₐₓ | (15) | (19) |
| I | f_{b1D} = fₘₐₓ, f_{b2D} = f_{mid}, f_{b3D} = fₘᵢₙ | (15) | (20) |

In the presence of a radial velocity v≠0 the beat frequencies shown with solid lines will be differently shifted, which is indicated by thin horizontal arrows in FIG. 17. If the Doppler frequency f_{D} is −45 MHz, the beat frequency f_{b1} of the first light source 16 is shifted to f_{b1D}=|0-45| MHz=45 MHz, the beat frequency f_{b2} of the second light source 17 is shifted to f_{b2D}=|33−45| MHz=12 MHz, and the beat frequency f_{b3} of the third light source 18 is shifted to f_{b3D}=|133−45| MHz=88 MHz.

In a real measurement, it is initially not known which Doppler-shifted beat peak belongs to which light source. In particular, it is also not known which beat peaks experience a “frequency reflection” at f=0 Hz. In the example shown, this is the case for the first light source 16 and for the second light source 17, but not for the third light source 18.

Table 1 shows a first step of a solution scheme according to this embodiment for the problem how the peaks can be correctly assigned to the three light sources. With three light sources 16, 17 and 18, the cases A to I can be distinguished. As long as the beat peaks do not overlap randomly, each power spectrum P(f) obtained by FFT contains three beat peaks having frequencies fₘᵢₙ, f_{mid} and fₘₐₓ in increasing order. The Doppler affected beat peaks associated with the light sources 16, 17 and 18 are designated with f_{b1D}, f_{b2D} and f_{b3D}. The second column in the table contains possible assignments of the measured beat frequencies to the peaks in the power spectrum. The third column refers to the equation for calculating a preliminary range R, and the fourth column refers to the equation for calculating preliminary velocities v₁, v₂ and v₃ for each light source 16, 17, 18.

In this first part of the solution scheme the following equations for calculating the distance R are used:

### Cases A and B:

$$R = \frac{c}{2} \frac{\frac{{f}_{b 2 D} - ( {f}_{b 1 D} \cdot \frac{{λ}_{1}}{{λ}_{2}} )}{{r}_{chirp 1} + {r}_{chirp 2}}}{1 - \frac{{r}_{chirp 1} \cdot ( 1 + \frac{{λ}_{1}}{{λ}_{2}} )}{{r}_{chirp 1} + {r}_{chirp 2}}} \qquad ( 13 )$$

### Cases C, D and E:

$$R = \frac{c}{2} \frac{\frac{{f}_{b 2 D} + ( {f}_{b 1 D} \cdot \frac{{λ}_{1}}{{λ}_{2}} )}{- {r}_{chirp 1} + {r}_{chirp 2}}}{1 + \frac{{r}_{chirp 1} \cdot ( 1 - \frac{{λ}_{1}}{{λ}_{2}} )}{- {r}_{chirp 1} + {r}_{chirp 2}}} \qquad ( 14 )$$

### Cases F, G, H and I:

$$R = \frac{c}{2} \frac{\frac{{f}_{b 2 D} - ( {f}_{b 1 D} \cdot \frac{{λ}_{1}}{{λ}_{2}} )}{- {r}_{chirp 1} - {r}_{chirp 2}}}{1 + \frac{{r}_{chirp 1} \cdot ( 1 + \frac{{λ}_{1}}{{λ}_{2}} )}{- {r}_{chirp 1} - {r}_{chirp 2}}} \qquad ( 15 )$$

The following equations for calculating preliminary velocities v₁, v₂ and v₃ are used:

### Case A:

$${v}_{1} = {λ}_{1} \vert \frac{1}{2} {f}_{b 1 D} - \frac{R \cdot {r}_{chirp 1}}{c} \vert \qquad ( 16 )$$

$${v}_{2} = {λ}_{2} \vert \frac{1}{2} {f}_{b 2 D} - \frac{R \cdot {r}_{chirp 2}}{c} \vert$$

$${v}_{3} = {λ}_{3} \vert \frac{1}{2} {f}_{b 3 D} - \frac{R \cdot {r}_{chirp 3}}{c} \vert$$

### Case B:

$${v}_{1} = - {λ}_{1} \vert \frac{1}{2} {f}_{b 1 D} + \frac{R \cdot {r}_{chirp 1}}{c} \vert \qquad ( 17 )$$

$${v}_{2} = - {λ}_{2} \vert \frac{1}{2} {f}_{b 2 D} + \frac{R \cdot {r}_{chirp 2}}{c} \vert$$

$${v}_{3} = - {λ}_{3} \vert \frac{1}{2} {f}_{b 3 D} + \frac{R \cdot {r}_{chirp 3}}{c} \vert$$

### Cases C, D and E:

$${v}_{1} = - {λ}_{1} \vert \frac{1}{2} {f}_{b 1 D} + \frac{R \cdot {r}_{chirp 1}}{c} \vert \qquad ( 18 )$$

$${v}_{2} = - {λ}_{2} \vert - \frac{1}{2} {f}_{b 2 D} + \frac{R \cdot {r}_{chirp 2}}{c} \vert$$

$${v}_{3} = - {λ}_{3} \vert - \frac{1}{2} {f}_{b 3 D} + \frac{R \cdot {r}_{chirp 3}}{c} \vert$$

### Cases F, G and H:

$${v}_{1} = - {λ}_{1} \vert \frac{1}{2} {f}_{b 1 D} + \frac{R \cdot {r}_{chirp 1}}{c} \vert \qquad ( 19 )$$

$${v}_{2} = - {λ}_{2} \vert \frac{1}{2} {f}_{b 2 D} + \frac{R \cdot {r}_{chirp 2}}{c} \vert$$

$${v}_{3} = - {λ}_{3} \vert - \frac{1}{2} {f}_{b 3 D} + \frac{R \cdot {r}_{chirp 3}}{c} \vert$$

### Case I:

$${v}_{1} = - {λ}_{1} \vert \frac{1}{2} {f}_{b 1 D} + \frac{R \cdot {r}_{chirp 1}}{c} \vert \qquad ( 20 )$$

$${v}_{2} = - {λ}_{2} \vert \frac{1}{2} {f}_{b 2 D} + \frac{R \cdot {r}_{chirp 2}}{c} \vert$$

$${v}_{3} = - {λ}_{3} \vert \frac{1}{2} {f}_{b 3 D} + \frac{R \cdot {r}_{chirp 3}}{c} \vert$$

Table 2 shows a second step of the solution scheme according to this embodiment. This table represents a binary decision tree that is used to determine, on the basis of the preliminary values for the velocity v₁, v₂ (see equation 21), which case A to I is present, and how then final values for the range R and the velocity v can to be calculated. In this calculation is has been taken into account that the measured beat peaks are not arbitrarily sharp, but can only be measured with the frequency resolution 1/T. Due to this limited frequency resolution, a certain reconstruction error rate must be expected, since the calculations of the preliminary velocities v₁, v₂ and vs cannot be compared with each other with arbitrary accuracy.

TABLE 2
Decision tree for computing final values for R and ν

| | Frequency | Computation of final values for |
|---|---|---|
| Ca | Assignment | range R and velocity ν |
| A | f_{b1D} = fₘᵢₙ, | IF (21) = true with X = A, |
| | f_{b2D} = f_{mid}, | THEN compute R according to (13) |
| | f_{b3D} = fₘₐₓ | and ν according to (22), ELSE Case B |
| B | f_{b1D} = fₘᵢₙ, | IF (21) = true with X = B, |
| | f_{b2D} = f_{mid}, | THEN compute R according to (13) |
| | f_{b3D} = fₘₐₓ | and ν according to (23), ELSE Case C |
| C | f_{b1D} = fₘᵢₙ, | IF (21) = true with X = C, |
| | f_{b2D} = f_{mid}, | THEN compute R according to (14) |
| | f_{b3D} = fₘₐₓ | and ν according to (24), ELSE Case D |
| D | f_{b1D} = f_{mid}, | IF (21) = true with X = D, |
| | f_{b2D} = fₘᵢₙ, | THEN compute R according to (14) |
| | f_{b3D} = fₘₐₓ | and ν according to (24), ELSE Case E |
| E | f_{b1D} = fₘₐₓ, | IF (21) = true with X = E, |
| | f_{b2D} = fₘᵢₙ, | THEN compute R according to (14) |
| | f_{b3D} = f_{mid} | and ν according to (24), ELSE Case F |
| F | f_{b1D} = fₘₐₓ, | IF (21) = true with X = F, |
| | f_{b2D} = f_{mid}, | THEN compute R according to (15) |
| | f_{b3D} = fₘᵢₙ | and ν according to (24), ELSE Case G |
| G | f_{b1D} = fₘₐₓ, | IF (21) = true with X = G, |
| | f_{b2D} = fₘᵢₙ, | THEN compute R according to (15) |
| | f_{b3D} = f_{mid} | and ν according to (24), ELSE Case H |
| H | f_{b1D} = f_{mid}, | IF (21) = true with X = H, |
| | f_{b2D} = fₘᵢₙ, | THEN compute R according to (15) |
| | f_{b3D} = fₘₐₓ | and ν according to (24), ELSE Case I |
| I | f_{b1D} = fₘₐₓ, | IF (21) = true with X = I, |
| | f_{b2D} = f_{mid}, | THEN compute R according to (15) |
| | f_{b3D} = fₘᵢₙ | and ν according to (24). |

The condition used to determine which case is present is defined as (21):

$$\vert {v}_{1 X} - {v}_{2 X} \vert \cdot \frac{2}{3} \cdot ( \frac{1}{{λ}_{1}} + \frac{1}{{λ}_{2}} + \frac{1}{{λ}_{3}} ) < \frac{1}{T} \qquad ( 21 )$$

$$AND$$

$$\vert {v}_{1 X} - {v}_{3 X} \vert \cdot \frac{2}{3} \cdot ( \frac{1}{{λ}_{1}} + \frac{1}{{λ}_{2}} + \frac{1}{{λ}_{3}} ) < \frac{1}{T}$$

$$AND$$

$$\vert {v}_{2 X} - {v}_{3 X} \vert \cdot \frac{2}{3} \cdot ( \frac{1}{{λ}_{1}} + \frac{1}{{λ}_{2}} + \frac{1}{{λ}_{3}} ) < \frac{1}{T}$$

This equation mathematically expresses that the preliminary velocity values obtained using the light produces by the first, second and third light source are all very similar.

For the computation of the final range R, Table 2 refers to equations (13) to (15) recited above, and for the computation of the final velocity v to the following equations (22) to (24):

$$v = {λ}_{1} \vert \frac{1}{2} {f}_{b 1 D} - \frac{R \cdot {r}_{chirp 1}}{c} \vert \qquad ( 22 )$$

$$v = - {λ}_{1} \vert - \frac{1}{2} {f}_{b 1 D} + \frac{R \cdot {r}_{chirp 1}}{c} \vert \qquad ( 23 )$$

$$v = - {λ}_{1} \vert \frac{1}{2} {f}_{b 1 D} + \frac{R \cdot {r}_{chirp 1}}{c} \vert \qquad ( 24 )$$

Cases A to I do not occur with equal frequency. Rather, case A dominates so that the decision tree does not have to be run through for most measurements. This significantly reduces the computational effort required to perform the decision tree analysis.

For typical LiDAR applications such as autonomously driving vehicles, a range error tolerance of 5 cm and a velocity tolerance of 5 cm/s is acceptable. On the basis of Monte Carlo simulations, it can be shown that for such tolerances more than 99.9% of the computations fulfill these tolerances. This percentage can be increased still further by increasing the chirp rate of the light sources 16, 17, 18 and/or the duration T of the measuring interval.

A part of the f_{cw} remaining mismeasurements can be identified by the fact that the computed values cannot occur in reality. For example, negative values for the range R or velocities |v|>70 m/s cannot occur in road traffic situations. The rest of the mismeasurements can be identified by plausibility analyses of temporally or spatially neighboring pixels.

FIG. 18 is a diagram showing how the signal-to-noise ratio (SNR) improves with the use of two or three light sources compared to the conventional prior art method. For the comparison it was assumed that both the total light source power and the total measurement duration are the same for all measurements. According to the invention, measurements are made with a longer chirp duration T in order to achieve the same beat peak height. In return, a significant time saving is achieved, because only one (in the case of three light sources) or two (in the case of two light sources) FFTs instead of three FFTs have to be performed sequentially.

In the comparison, a maximum object distance of 300 m has been assumed, which corresponds to a time of flight ToF=2 μs. This unavoidable runtime is the reason why the approach according to the invention results in an improved SNR compared to the prior art approach. This is most easily understood by assuming three sequential FFT measurements 5 each having a duration T=2 μs for the conventional measurement. Even with infinitely high laser power, no signal photons would be obtained from an object at a distance of 300 m, since the measurements are finished before the photons arrive at the scanner system. If, on the other hand, one performs an FFT measurement with 6 μs (=3·T), signal photons reach the measurement system for the duration 3·T−ToF=4 μs. It is therefore advantageous with regard to the SNR to perform fewer FFT measurements with longer chirp durations T. One of the advantages of this embodiment is that the dead time, in which no photons are yet measurable, is significantly reduced, since the dead time occurs with every FFT.

The diagram in FIG. 18 shows how many times the SNR improves, according to the invention, as a function of the chirp duration T. It can be seen that an FFT measurement with three simultaneously operating light sources, i.e. with three 3 beat peaks in one FFT, always offers the greatest SNR advantage. This must be traded off against the disadvantage of higher system complexity due to the provision of a third light source and the electronics that are required for its control.

1. An FMCW LiDAR system for simultaneous range and velocity measurement, comprising:
a first light source configured to produce first light having a first frequency that varies the first frequency varies according to a chirp rate CR1 during a first portion of a measurement interval and according to a chirp rate CR2 during a second portion of the measurement interval,
a second light source configured to produce second light having a second frequency that is constant,
an optical combiner configured to combine the first light and the second light, thereby obtaining measuring light having at least two different frequency components during the measurement interval,
a splitter configured to separate the measuring light into reference light and output light,
a scanning unit configured to direct the output light towards an object along different directions and to receive input light that is obtained by reflection of the output light at the object,
a detector configured to detect a superposition of the reference light and the input light, and
a computing unit configured to compute unambiguously a range to the object and a relative velocity between the system and the object by analyzing beat frequencies resulting from the superposition detected by the detector,
the computing unit is configured to compute beat frequencies separately for each portion of the measurement interval, and to compute a range to the object and a relative velocity between the system and the object by analyzing the beat frequencies measured during both portions of the measurement interval,
wherein
the computing unit is further configured to remove ambiguities due to Doppler frequency shifts by performing a decision tree analysis.

2. The system of claim 1, wherein the computing unit is configured, when performing the decision tree analysis, to determine, separately for each of the first and second portion of the measurement interval, how many beat frequencies have been measured, and whether there is a beat frequency that occurs in both portions of the measurement interval.

3. The system of claim 2, wherein the chirp rate CR1 is a positive chirp rate so that the frequency increases during the first portion of the measurement interval, and wherein the chirp rate CR2 is a negative chirp rate so that the frequency decreases during the second portion of the measurement interval.

4. The system of claim 1, comprising an optical circulator connecting the splitter, the scanning unit and the detector so that the output light is directed towards the scanning unit and the input light is directed towards the detector.

5. A method for simultaneous range and velocity measurement in an FMCW LiDAR system, comprising the following steps:
a) producing first light having a first frequency that varies according to a chirp rate CR1 during a first portion of a measurement interval and according to a chirp rate CR2 during a second portion of the measurement interval;
b) producing second light having a second frequency that is constant;
c) combining the first light and the second light, thereby obtaining measuring light having at least two different frequency components during the measurement interval;
d) separating the measuring light into reference light and output light;
e) directing the output light towards an object along different directions and receiving input light that is obtained by reflection of the output light at the object;
f) detecting a superposition of the reference light and the input light;
g) computing beat frequencies separately for each portion of the measurement interval; and
h) computing a range to the object and a relative velocity between the system and the object by analyzing the beat frequencies computed for each portion of the measurement interval;
wherein step h) includes the step of removing ambiguities due to Doppler frequency shifts by performing a decision tree analysis.

6. The method of claim 5, wherein, when performing the decision tree analysis, it is determined, separately for each of the first and second portion of the measurement interval, how many beat frequencies have been measured, and whether there is a beat frequency that occurs in both portions of the measurement interval.

7. The method of claim 5, wherein the chirp rate CR1 is a positive chirp rate so that the frequency increases during the first portion of the measurement interval, and wherein the chirp rate CR2 is a negative chirp rate so that the frequency decreases during the second portion of the measurement interval.
